(19) United States
(12) Patent Application Publication
(10) Pub. No.: US 2007/0197191 A1
(43) Pub. Date: Aug. 23, 2007

(54) METHOD FOR CHECKING A CONFIGURATION OF A WIRELESS COMMUNICATION DEVICE AND RELATED DEVICE

(76) Inventor: Ben-Chuan Du, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/675,092

(22) Filed: Feb. 15, 2007

(30) Foreign Application Priority Data
Feb. 22, 2006 (TW) 095105967

(51) Int. Cl. H04M 1/66

(52) U.S. Cl. 455/411

(57) ABSTRACT

A method for checking a wireless communication device includes detecting whether the configuration of the wireless communication device conforms to a predetermined rule when a status of the wireless communication device conforms to a predetermined status, and executing a corresponding procedure when the configuration of the wireless communication device does not conform to the predetermined rule.

### BACKGROUND OF THE INVENTION

1. Field of the Invention

The present invention relates to a method for automatically checking a configuration of a wireless communication device, and more specifically, to a method for checking a status of a configuration of a wireless communication device and executing a corresponding procedure.

2. Description of the Prior Art

Portable electronic devices, e.g. mobile phones, not only provide basic communication functions, but also include a variety of multimedia functions and capability to connect with peripheral devices. Therefore, embedded software of the mobile phones is becoming more complex, and a probability that interactions will occur between different functions increases. For example, most mobile phones are capable of operating accessory functions, such as a contact list, a calls history, or a calculator, while working on communication functions. However, if an error occurs in the attached function, it is possible that the communication function will also fail, or the mobile phone will shut down. Although increased functionality makes the portable electronic devices more convenient for users, the probability of interactions occurring between different functions increases relatively.

Generally speaking, a mobile phone includes a flash memory for storing program code, mobile phone settings, and other data. Theoretically, the program code stored in the flash memory will not reprogram itself. However, mobile phones are capable of rewriting the flash memory. An error occurring while altering certain sections of data, or other issues, such as damage caused to electronic portions of the flash memory by electrostatic discharge, could cause the program code stored in the flash memory to be rewritten.

For example, when users execute a query on the contact list and execute a communication function of the mobile phone at the same time, it is possible that the communication line cuts off or the mobile phone shuts down due to an error occurring in the program code related to accessing the contact list.

When the error occurs in the embedded software program of the mobile phone, in general, the user will be aware that an internal function of the mobile phone has failed to execute after starting up a certain specific function. Then, the user must take their mobile phone to a Service Center for update or repair, which is a great inconvenience to the user. Therefore, the mobile phone having no ability to display an early warning to the user frustrates the user in use when the internal program is rewritten or an error occurs.

### SUMMARY OF THE INVENTION

The present invention discloses a method for checking a status of a configuration of a wireless communication device and executing a corresponding procedure, which comprises detecting whether the configuration of the wireless communication device conforms to a predetermined rule when the status of the configuration of the wireless communication device conforms to a predetermined status, and executing the corresponding procedure if the configuration of the wireless communication device does not conform to a predetermined rule.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a function diagram of the present invention mobile phone.

FIG. 2 is a flowchart of the present invention mobile phone detecting configuration.

### DETAILED DESCRIPTION

In order to solve the problems in the prior art, the present invention provides a method for automatically checking whether a program code stored in a mobile phone is rewritten or if an error occurs, and for giving an early warning to a user that executing a specific function may cause an error.

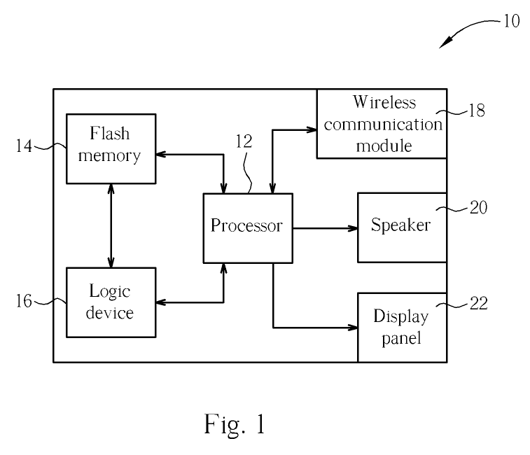

Please refer to FIG. 1. FIG. 1 is a function diagram of a mobile phone 10 according to the present invention. The mobile phone 10 comprises a processor 12, a flash memory 14, a logic device 16, a wireless communication module 18, a speaker 20, and a display panel 22. The processor 12 controls operations of the mobile phone 10. The flash memory 14 stores data such as programs and settings. The wireless communication module 18 transmits and receives wireless communication signals. The speaker 20 generates acoustic signals. And the display panel 22 displays data.

When the mobile phone 10 boots up, switches to an idle state, executes a periodic examination of a configuration of the wireless communication device, or executes specific functions, the logic device 16 will detect whether the program stored in the flash memory 14 conforms to a predetermined rule or not. If false, the logic device 16 indicates that an error has occurred or the program has been rewritten. Subsequently, the user is given a warning through the speaker 20, which generates a corresponding acoustic signal, or through the display panel 22, which displays corresponding text or patterns to notify the user that certain specific functions of the mobile phone 10 will fail to execute due to errors, or that unpredicted errors may occur if the specific function executes.

A variety of arithmetic rules can be utilized to detect whether errors have occurred in the program stored in the flash memory 14 or the program has been rewritten. One embodiment of the present invention uses a HASH algorithm as a predetermined rule of the examination.

The method begins with dividing the software program into a plurality of segments. Based on the HASH algorithm, such as MD4 (message-digest algorithm 4) or MD5 (message-digest algorithm 5), an initial eigenvalue corresponding to each segment is calculated and stored in the mobile phone 10. Then, a corresponding table is established to label which segment is related to which function. When the logic device 16 detects the configuration of the mobile phone 10, the eigenvalue of each segment is recalculated according to the same foregoing algorithm and the recalculated eigenvalue is compared with the initial eigenvalue. If the result of the comparison is different, this segment is recorded. Finally, before executing the specific function, the record of detecting configurations is checked to confirm whether an error has occurred in the specific function. If there has been an error, the mobile phone 10 gives warning signals to inform the user of the possibility of the system shutting down or of data processing failing, and subsequently enquires the user whether the system should continue executing the specific function. If the user decides to continue, the specific function starts to execute; otherwise, the specific function does not execute.

Furthermore, if an error occurs after the configuration has been detected, the mobile phone 10 not only gives the warning signals but also is capable of automatically connecting to a predetermined server, such as a phone number or an IP address, in an idle period to update software. Preferably, the server company should pay any fees to free users from inconvenience. The mobile phone 10 can also request another mobile phone having a same prototype and a same version of the software to transmit the correct program. Therefore, the present invention mobile phone 10 is capable of not only detecting whether an error occurs in the program but also automatically updating broken programs, thereby preventing users from having to take their mobile phones to the Service Center for repair.

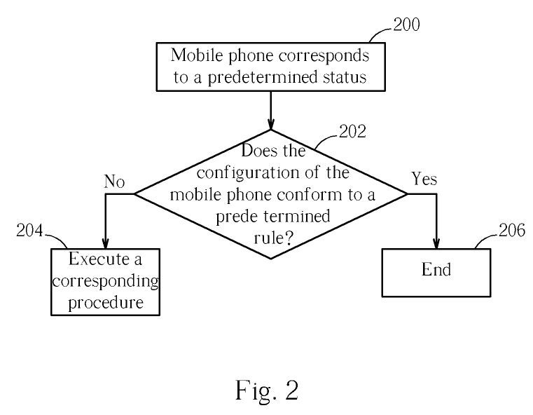

Please refer to FIG. 2. FIG. 2 is a flowchart of the present invention method of detecting the configuration utilized in the mobile phone 10, the method comprising:

Step 200: The mobile phone 10 conforms to a predetermined status, such as a booting up state, an idle state, executing the periodic examination of the configuration of the mobile phone 10, or executing the specific function.

Step 202: The logic device 16 detects whether the configuration of the mobile phone 10 conforms to the predetermined rule by calculating an eigenvalue of each segment, which is based on a variety of arithmetic rules such as the HASH algorithm, to determine whether an error has occurred in the program or not. If so, go to Step 204; otherwise, go to step 206.

Step 204: Owing to an error in the program, the mobile phone 10 records the related error segment. When the user feels like executing the specific function, if a corresponding segment matches the error segment, the mobile phone 10 gives warning signals and automatically updates program data during the idle period.

Step 206: No errors are detected in the program. Detection terminates.

The wireless communication device can be an electronic device, such as a cellular phone or a personal digital assistant (PDA).

Compared with the prior art, the present invention provides a method for automatically detecting the configuration of the wireless communication device to determine whether an error occurs, and is capable of giving a preliminary warning of a possible error occurring to the user when executing the specific function in order to prevent the user from unwittingly executing the specific function. In addition, the present invention wireless communication device is capable of automatically updating the broken program data, which frees the user from having to go to the Service Center for repair, and strengthens the functionality of the wireless communication device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for checking a wireless communication device, the method comprising:
detecting whether a configuration of the wireless communication device conforms to a predetermined rule when a status of the wireless communication device conforms to a predetermined status; and
executing a corresponding procedure when the configuration of the wireless communication device does not conform to the predetermined rule.

2. The method of claim 1 wherein detecting whether the configuration of the wireless communication device conforms to the predetermined rule comprises detecting whether a plurality of segments of the wireless communication device conforms to a corresponding arithmetic rule.

3. The method of claim 2 wherein the arithmetic rule comprises a HASH algorithm.

4. The method of claim 3 wherein the arithmetic rule comprises a message-digest algorithm 4 (MD4) and a message-digest algorithm 5 (MD5).

5. The method of claim 1 wherein the predetermined status comprises the wireless communication device booting up, the wireless communication device switching to a suspended state, or the wireless communication device executing a periodic examination.

6. The method of claim 1 wherein executing a corresponding procedure comprises sending a warning signal, the wireless communication device automatically connecting to a server for updating programs, or the wireless communication device wirelessly transmitting a signal to request another wireless communication device to transmit programs and data.

7. A wireless communication device comprising:
a flash memory for storing data; and
a logic device for detecting whether a configuration of the wireless communication device conforms to a predetermined rule when a status of the wireless communication device conforms to a predetermined status and for executing a corresponding procedure when the configuration of the wireless communication device does not conform to the predetermined rule.

8. The wireless communication device of claim 7 further comprising a display panel for displaying data.

9. The wireless communication device of claim 7 further comprising a wireless communication module for connecting to a server.

10. The wireless communication device of claim 7 further comprising a speaker for generating audio signals.

11. The wireless communication device of claim 7 being a cellular phone or a personal digital assistant (PDA).
